(19) United States
(12) Patent Application Publication
(10) Pub. No.: US 2011/0236164 A1
(43) Pub. Date: Sep. 29, 2011

(54) LIFT DEVICE FOR PERSONALIZATION MACHINE AND PERSONALIZATION MACHINE EQUIPPED WITH A LIFT DEVICE

(75) Inventors: Benoit Berthe, Orleans (FR); Frederic Beulet, Meung sur Loire (FR); Sebastien Michenet, Saint Denis de l'Hotel (FR)

(73) Assignee: DATACARD CORPORATION, Minnetonka, MN (US)

(21) Appl. No.: 13/132,703

(22) PCT Filed: Dec. 4, 2009
(86) PCT No.: PCT/EP2009/066427

§ 371 Date: Jun. 3, 2011

(30) Foreign Application Priority Data
Dec. 5, 2008 (FR) 08/06830

(51) Int. Cl. B65G 35/00; B65G 49/00

(52) U.S. Cl. 414/222.01

(57) ABSTRACT

A lift device for personalization machine(s) for cards, in particular chip cards, placed at the output of a first transfer device and at the input of a second transfer device, the first transfer device being located at a height greater than the height of the second transfer device. At least one pair of shafts are spaced apart by a distance greater than the dimensions of the cards transversally to their direction of movement, each of the shafts being parallel to the direction of movement and equipped with a plurality of flaps oriented parallel to the shafts and having dimensions arranged to support at least a part of the cards and radially distributed around the shaft. The shafts of a pair being driven synchronously inward in rotation by at least one driving mechanism, so that two flaps guide a card during its descent in the lift device.

The present invention relates to the field of machines for the personalization of media such as cards, in particular chip cards. The present invention relates more particularly to a lift device for a card personalization machine and a card personalization machine equipped with such a lift.

Personalization machines, in particular for chip cards, are known from the prior art, arranged for personalizing cards by various personalization stations allowing laser marking and/or inkjet marking and/or labeling and/or data recording in the chip, etc. These personalization machines comprise in general at least one transfer device conveying the cards to be personalized from an input to an output of the machine, and optionally from one personalization station to another within the machine. Transfer devices operating continuously with a determined feed speed and transfer devices operating step by step with a determined feed step are known. Personalization machines are also known, comprising several personalization stations located at different heights within the machine (on different levels).

A first problem in the field of personalization machines relates to the need to pass either from a step-by-step type transfer to a continuous type transfer and/or vice-versa in personalization machines comprising these two types of transfer devices, or between two transfer devices of the same type, having a different or identical feed step or speed, or between two personalization machines. A second problem relates to the need to control the change of level of the cards to be personalized in the machines comprising several levels or between two machines, the transfer devices of which are located at a different height. A third problem relates to the need to control the correct positioning on the transfer devices of the cards to be personalized, in particular during a change of level or on passing between two transfer devices. In fact, in general, it is necessary to ensure that the media to be personalized are correctly conveyed individually and that they are delivered in front of each station at the correct moment.

In this context, it is beneficial to propose a solution making it possible to control the passage of the media to be personalized from one transfer device to another.

The purpose of the present invention is to overcome certain problems of the prior art by proposing a device for a card personalization machine making it possible to control the passage of the media to be personalized from one transfer device to another.

This purpose is achieved by a lift device for machine(s) for the personalization of cards, in particular chip cards, placed at the output of a first transfer device of a personalization machine and at the input of a second transfer device, the first transfer device being located at a height greater than the height at which the second transfer device is located, the two transfer devices conveying the cards in a direction of movement, characterized in that it comprises at least one pair of shafts spaced apart by a distance greater than the dimensions of the cards transversally to their direction of movement, each of the shafts being parallel with the direction of movement and equipped with a plurality of N flaps oriented parallel to the shaft, having dimensions arranged for supporting at least a part of the cards and radially distributed around the shaft every 360°/N, the shafts of a pair being inwardly driven in rotation in a synchronous fashion by at least one driving means, such that two flaps guide a card during its descent in the lift device.

According to another feature, the shafts each comprise N=4 flaps and are driven in rotation by steps of a quarter-turn.

According to another feature, the device comprises two pairs of shafts driven in rotation in a synchronous fashion, one pair, called the upper pair, being placed substantially in or below the plane of the first transfer device and one pair, called the lower pair, being placed between the upper pair and the second transfer device.

According to another feature, at least one sensor is placed at the output of the first transfer device and arranged to detect the arrival of a card and trigger the rotation of the shafts.

According to another feature, at least one sensor is placed at the input of the second transfer device and arranged to detect the arrival of a card on the second transfer device.

According to another feature, the second transfer device operates by feed steps and the sensor placed at the input of this second device is also arranged to control the feed of the latter when a card is detected.

According to another feature, the distance separating the shafts of the lower pair is less than the distance separating the shafts of the upper pair.

According to another feature, at least one of the transfer devices is a conveyor belt.

According to another feature, at least [one] of the transfer devices is a is cleated conveyor.

According to another feature, the flaps protrude, for each pair of shafts, with respect to a side wall, the distance separating these walls close to the second transfer device being less than the distance separating these walls close to the first transfer device, so as to guide the cards during their descent in the lift device.

According to another feature, a wall, called a joining wall, oriented in a substantially vertical plane perpendicular to the rotation shafts is located within the height separating the output of the first transfer device and the input of the second transfer device.

According to another feature, the joining wall is substantially inclined in the direction of feed of the transfer devices, so as to guide the cards during their descent in the lift device.

According to another feature, a wall called a stop wall, oriented in a substantially vertical plane perpendicular to the rotation shafts is located close to the end of the shafts opposite the output of the first transfer device.

According to another feature, the stop wall is substantially inclined in a direction opposite to the direction of feed of the transfer devices, so as to guide the cards during their descent in the lift device.

According to another feature, blowing means are placed above the space separating the rotation shafts and are arranged in order to generate a flow pressing the cards onto the flaps and facilitating the descent of the cards in the lift device.

According to another feature, the flow generated by the blowing means is synchronized with the rotation of the shafts.

According to another feature, the device is located in a personalization machine comprising the two transfer devices.

According to another feature, the device is located between two personalization machines each comprising one of the two transfer devices.

A further purpose of the present invention is to propose a card personalization machine making it possible to control the passage of the media to be personalized from one transfer device to another.

This purpose is achieved by a card personalization machine, in particular for chip cards, comprising at least one card personalization station and at least one transfer device, characterized in that it comprises a lift device according to the invention.

Other features and advantages of the present invention will become more clearly apparent from reading the following description, with reference to the attached drawings, in which:

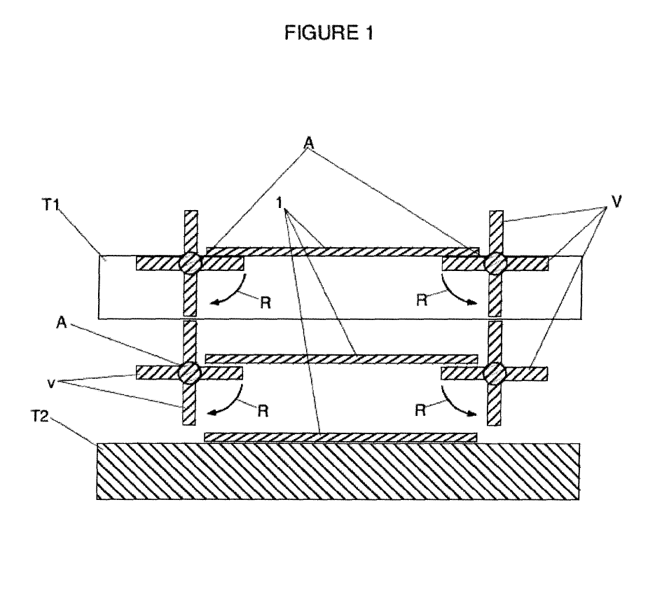

FIG. 1 shows a cross section view of a lift device according to an embodiment of the invention, in a section plane perpendicular to the direction of movement of the cards,

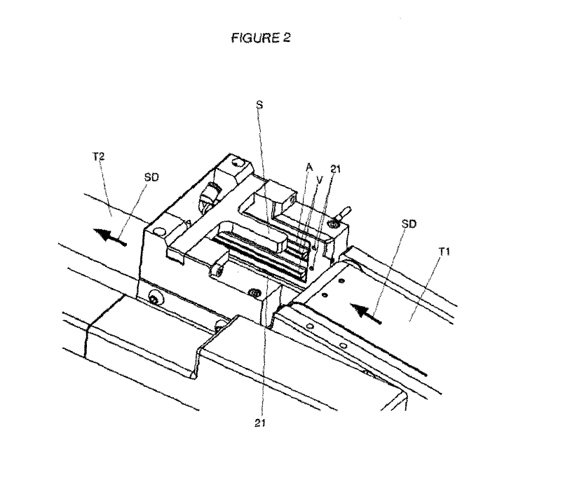

FIG. 2 shows a perspective view of a lift device between two transfer devices according to an embodiment of the invention,

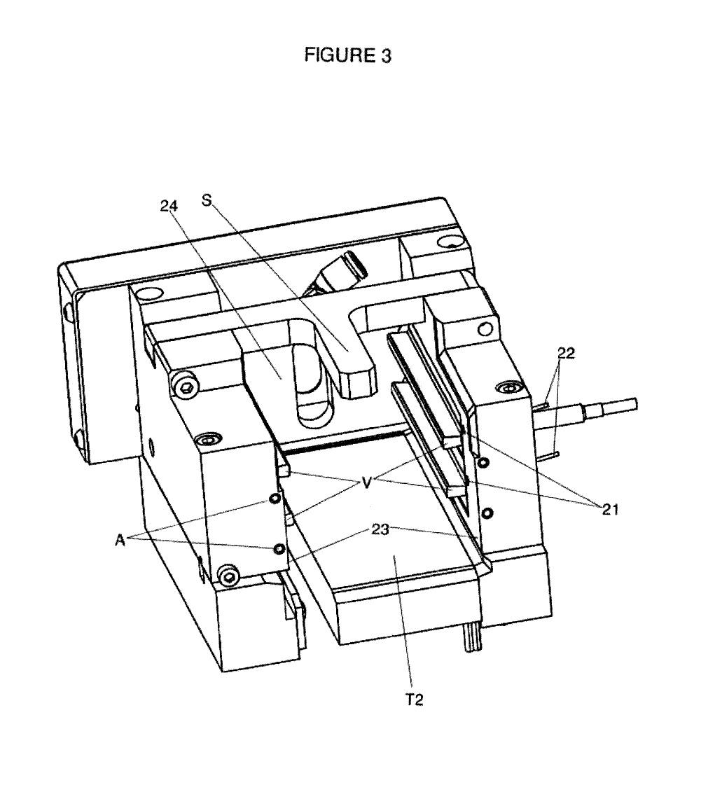

FIG. 3 shows a perspective view of a lift device on a transfer device according to an embodiment of the invention,

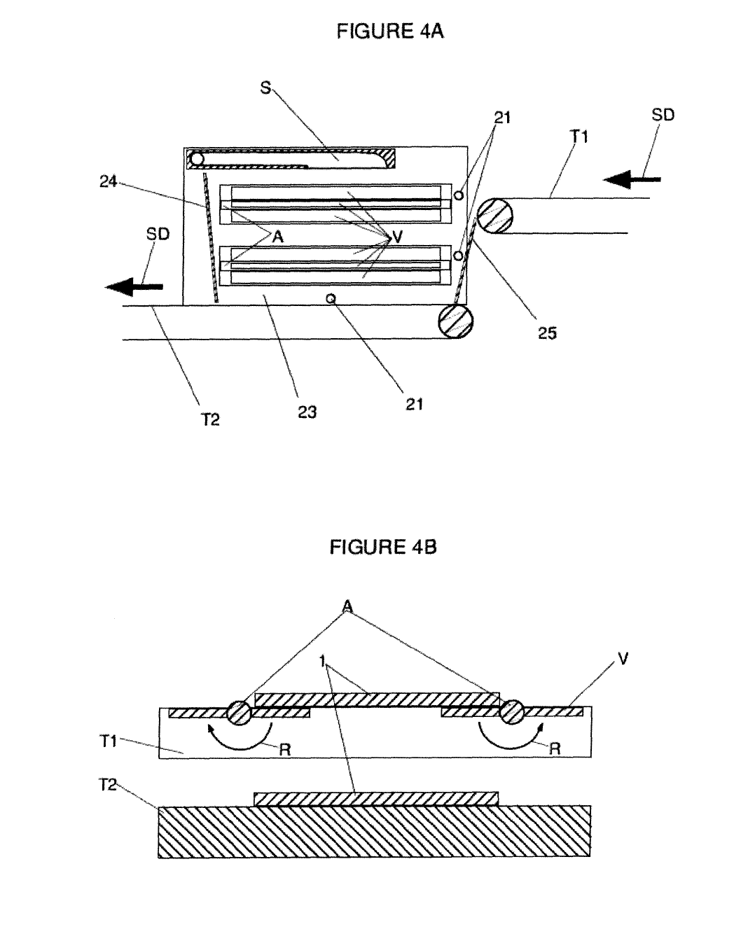

FIG. 4A shows a cross section view of a lift device between two transfer devices according to an embodiment of the invention, in a substantially vertical cross section view, parallel with the direction of movement of the cards and FIG. 4B shows a cross section view of a lift device according to an embodiment of the invention, in a section plane perpendicular to the direction of movement of the cards.

The present invention relates to a lift device for machine(s) for the personalization of cards (1), in particular chip cards, and relates to a personalization machine comprising such a lift device.

Although the description hereafter refers by way of example to the personalization of cards, in particular chip cards, personalization machines often allow various types of media to be personalized. Media that can be personalized using personalization machines can consist of other media or portable objects, for example plastic-covered, including cards with or without a chip, or cards with or without a magnetic strip. By the term “personalization machine”, is meant here any type of machine allowing portable media or objects to be personalized using one or more personalization stations, such as for example stations for laser marking and/or inkjet marking and/or labeling and/or recording of data in the chip, etc.

The lift device according to the invention can be mounted in a card personalization machine comprising two transfer devices located at different heights or between two card personalization machines each comprising at least one transfer device, the two transfer devices, between which the lift device according to the invention is placed, being located at different heights. Thus, the invention also relates to a card personalization machine (1), in particular for chip cards, comprising at least one card personalization station and at least one transfer device, this machine being characterized in that it comprises a lift device according to the invention.

By the term “transfer device”, is meant any type of device conveying the cards to be personalized from one station to another, in the same machine or from one machine to another. Thus, at least one of the transfer devices (T1, T2) can be a conveyor belt. For example, a conveyor belt can comprise a continuous band running between two end rollers, at least one of which is driven in rotation by a motor (as shown partially in FIG. 4A). Similarly, at least one of the transfer devices (T1, T2) can be a belt having cleats, for example as described in the French patent application by the same applicant published under number FR 2883503. This transfer device can be formed by a continuous notched belt running between two end pulleys, at least one of which is motor-driven. Gripping means such as cleats are mounted in pairs at regular intervals on this endless belt, the distance between two consecutive cleats corresponding to the length of a chip card, when the card to be transferred is in the horizontal position on the transfer device. Each pair of cleats distant by one length of a chip card can be adjacent to the following pair by a shorter length. The cleats allow the chip cards to be held while they are conveyed within the personalization machine, in particular from one personalization station to another. For further detail on the embodiment of the cleats and the transfer device, reference can be made to European Patent Application 0,589,771 from the same applicant. It will also be noted that a lift device according to the invention can also be used for cards that are already personalized and are not sent to another personalization station but to a collecting device, such as for example a stacker.

The lift device can be used in machines requiring discontinuous movement (by feed steps) and/or a continuous movement, such as for example machines having personalization stations such as inkjet stations (for example of the single-head monochrome type or of the 3 or 4 head colour type), stations for labeling, magnetic strip encoding in the case of magnetic strip cards, folding sheets of paper to receive the personalized cards, etc. This lift device according to the invention makes it possible to change from a step-by-step transfer mode to a continuous mode or vice-versa and makes it possible to control accurately the number of cards (for example in an accumulating device) whatever the start and stop modes or the technical incidents of the machine may be. In particular, the lift device is particularly suited especially for passing from a continuous movement transfer device to a discontinuous movement transfer device (of the step by step type), on two different levels. Moreover, certain embodiments of the invention make it possible to monitor the cards individually in order to prevent any risk of inversion or card tracking error and to ensure that cards that are correctly separated from each other do not become superimposed during their passage through the lift device due to a malfunction. Sensors detecting the cards during their passage through the lift device make it possible to prevent this type of superimposition problem. However, in personalization machines, cards have frequently been personalized and have a unique number. These cards must be stacked on output from the machine, without any card in the sequence missing and without disorder. Verification of the correct presentation of the cards in the lift device equipped with at least one sensor makes it possible to ensure that the machine is operating correctly. In certain embodiments, the machine comprises at least one sensor on each level, in order to verify that the card is at the expected level.

The lift device according to the invention is placed at the output of a first transfer device (T1) of a personalization machine and at the input of a second transfer device (T2), the first transfer device (T1) being located at a height greater than the height at which the second transfer device (T2) is located. The two transfer devices convey the cards (1) in a direction of movement (SD). The lift device according to the invention is characterized in that it comprises at least one pair of shafts (A) spaced apart by a distance greater than the dimensions of the cards (1) transversally to their direction of movement (SD). For example, FIG. 1 shows a cross section view of an embodiment of the invention, in which the two shafts are separated by a distance slightly greater than the width of the cards (for example less than 2% of the dimension of the card in the example shown, but more generally, less than 20% of the dimension of the card). The distance between the shafts must be greater than the width of the cards by a distance sufficient to allow the shafts to rotate and the cards to pass between the flaps during rotation regardless of the thickness of the cards (this thickness being overdimensioned in the example of FIG. 1). These shafts are equipped with 4 flaps each and it is understood from this figure that a (horizontal) flap of each shaft carries the card, while another (vertical) flap allows the card to be centred with respect to the two shafts. Thus, any card which is not centred and/or oriented correctly on the transfer device is accurately centred in the lift device due to the fact that the 2 vertical flaps guide the card during its feed in the lift device under the action of the first transfer device (T1). Moreover, in certain embodiments, in particular in said case of shafts separated by a distance adjusted to the width of the cards, recentring can be provided upstream by a funnel at the input of the lift device. Such a funnel can comprise a portion of the side walls flared out in the direction of the first transfer device which become progressively narrower on approaching the rotation shafts (A).

Each of the shafts (A) is parallel to the direction of movement (SD) and equipped with a plurality of N flaps (V) oriented parallel to the shaft (A). The flaps have dimensions arranged to support at least a part of the cards (1). For example, as shown in the Figures, the flaps can have a substantially rectangular shape and be placed such that at least a part of their surface supports at least a part of the cards during descent in the lift device. It will be noted that the term “lift” is used here to denote the fact that the device allows the cards to be made to change level and that it makes it possible for the cards to be lowered. The flaps (V) are radially distributed around their shaft every 360°/N. The shafts (A) of a pair are synchronously driven by at least one driving means, in rotation (R) towards the inside and towards the bottom of the lift device, so that two flaps (V) guide a card (1) during its descent in the lift device. In an embodiment of the invention, the driving means operate with a rotation step of 1/N turn. In other embodiments, the driving means can operate continuously. In these embodiments, and in particular in the case of a continuously-operating driving means, the operation of the driving means can be slaved to detection of a card at the input of the lift device.

In an embodiment of the invention, the shafts (A) each comprise four flaps (V) and are driven in rotation (R), by a quarter turn (for example stepwise), as shown in FIG. 1. In the embodiment in FIG. 1, the device comprises two pairs of shafts (A) driven synchronously in rotation, one pair, called the upper pair, being placed substantially in the plane of, or below, the first transfer device (T1) and one pair, called the lower pair, being placed between the upper pair and the second transfer device (T2). The presence of these two pairs of shafts makes it possible to guide the descent of the cards in 3 stages, as shown in FIG. 1. A first card (1) arriving in the lift device rests on two flaps of the upper pair, then, after a rotation of ¼ turn of the shafts, is positioned on the lower pair while a second card (1) can be received on the upper pair. Then, after rotation of a further quarter of a turn, the first card (1) is positioned on the second transfer device (T2), ready to be conveyed elsewhere, while the second card (1) is positioned on the lower pair and a third card (1) can be received on the upper pair. This embodiment is particularly advantageous as it allows a progressive descent of the cards.

In the embodiment of FIG. 4B, the lift device comprises only one pair of shafts (A) each comprising only two flaps (V). In embodiment variants having 2 flaps per shaft, the cards entering the device are not recentred by vertical flaps as these are absent, but they can be more or less recentred by the shaft itself, the dimensions of which can be such that a part of the shaft protrudes at the edge of the flap and optionally allows the cards to be recentred. Moreover, in variant embodiments comprising only one pair of shafts, the descent of the card is not as progressive as with several pairs of shafts, which can pose problems of positioning the card when the lowering distance is significant. Embodiments having 4 flaps therefore make it possible to provide correct positioning of the cards and a progressive descent which has less risk of offsetting the card during the descent. Moreover, as mentioned previously, when the cards pass through several pairs of shafts during their descent, the flaps of one pair protect the lower stage (one pair located below) from any additional card arriving too soon (which may have been incorrectly positioned in the first transfer device, for example interposed between two cards) in the lift device, thus preventing this additional card from being superimposed onto a card that is in the process of descent. It will be noted that the invention allows other embodiments in which the lift device comprises only one pair of shafts (A) each comprising 4 flaps (V) or more. It will also be noted that the invention allows other embodiments in which the lift device comprises several pairs of shafts (A) each comprising 2 flaps or more. In the example of FIG. 4B, the rotation (R) necessary to deposit a card on the second transfer device (T2) is one half-turn. A relatively progressive rotation would make it possible to guide the cards during their descent. In the example shown, the dimensions of the flaps, transversally to the direction of movement (SD), are larger than in the embodiment of FIG. 1, so as to compensate for the fact that there is only one pair of shafts (A) having 2 flaps (V) to guide the cards.

In operation, it is understood that a card entering the lift device is centred by the latter between the rotation shafts. The card then rests on at least a portion of two flaps. During the rotation of the shafts towards the inside and the bottom of the device, the card thus descends between the two shafts. In the case of shafts having 4 flaps, when the 2 flaps descend by the rotation of the two shafts, the 2 following flaps immediately prevent the premature arrival of another card in the lift device, then are in position to receive another card. In the case of shafts having 2 flaps, when two flaps lower the card, the opposite flaps progressively return to the vertical position, then are in a position preventing another card arriving, but only after a quarter-turn of rotation, then finally are in position to receive the following card.

As shown particularly in FIGS. 2 and 3, in certain embodiments, at least one sensor (21) is placed at the output of the first transfer device T1. This sensor is arranged to detect the arrival of a card (1) and, in the case of a driving means operating stepwise, to initiate the rotation (R) of the shafts (A). The sensors described here can be of various kinds and for example comprise at least one optical or laser sensor. This type of sensor (21) can be linked by an optical fibre (22, FIG. 3) to a control system (not shown) controlling the feed of the cards within the machine. FIGS. 2 and 3 show embodiments in which a second sensor (21) is located at the level of the lower pair to detect the arrival of the cards on the flaps of the lower pair. Thus the passage of the cards correctly from one pair to another is checked. As shown particularly in FIG. 3, in certain embodiments at least one sensor (21) is placed at the input of the second transfer device (T2) and arranged to detect the arrival of a card (1) on the second transfer device (T2). In the case where the second transfer device (T2) operates by feed steps, this sensor (21) placed at the input of this second device (T2) is also arranged to check the feed of the latter when a card (1) is detected. Thus, this sensor (21) allows a control system (for example a data processing system linked to the device) to synchronize the feed of the second transfer device with the detection of the arrival of a card (1) on the latter. This embodiment is particularly effective for passing from a first, continuous operation transfer device (T1) to a second, discontinuous operation transfer device (T2).

In embodiments comprising several pairs, a variant embodiment consists in that the distance separating the shafts (A) of the lower pair is less than the distance separating the shafts (A) of the upper pair. Thus, the cards that pass from one pair to another are progressively guided and recentred. For example, the shafts of the upper pair of FIG. 1 can be spaced slightly further apart than shown, and than those of the lower pair. In the case of more [than] two pairs of shafts (3, 4 or more), there can be a reduction of this distance as the descent takes place, or a reduction of the distance on the last pairs only. These variant embodiments facilitate the progressive recentring of the cards arriving in the device. Thus very badly oriented cards entering the device have less difficulty in being admitted therein (due to the large space between the shafts of the first pair) and a progressive recentring takes place during the descent of the cards from one pair to another.

As shown particularly in FIGS. 2 and 3, the shafts (A) are mounted in side walls (23) of the lift device. The flaps (V) protrude, for each shaft (A) of a pair, with respect to this side wall (23). In certain embodiments, these side walls are inclined towards the inside of the lift device, i.e. the distance separating the side walls (23) close to the second transfer device (T2) is less than the distance separating these walls (23) close to the first transfer device T1, so as to guide the cards (1) during their descent in the lift device. In certain embodiments, the side walls are inclined only below the lower pair and are perfectly vertical at the level of the rotation shafts of each pair.

As shown particularly in FIG. 4A, a wall (25), called a joining wall, oriented in a substantially vertical plane perpendicular to the rotation shafts (A) is located within the height separating the output of the first transfer device (T1) and the input of the second transfer device (T2). In certain embodiments, this joining wall (25) is substantially inclined in the direction of feed (SD) of the transfer devices (T1, T2), so as to guide the cards (1) during their descent in the lift device. FIG. 4A also particularly shows a wall (24), called a stop wall. This stop wall (24) is oriented in a substantially vertical plane perpendicular to the rotation shafts (A) and located close to the end of the shafts (A) opposite the output of the first transfer device T1. The cards arriving in the lift device are stopped by this wall, making it possible to prevent them going too far. In certain embodiments, this stop wall (24) is substantially inclined in a direction opposite to the direction of feed (SD) of the transfer devices (T1, T2), so as to guide the cards (1) during their descent in the lift device. The invention provides for various combinations of the side, joining and stop walls, each being capable of being inclined or not according to the various combinations. Preferably, at least the stop and joining walls are inclined in order to centre the cards in the direction of feed. The positions of the walls with respect to the transfer devices (T1, T2) and the distances separating, respectively, the side walls from each other and the joining and stop walls, can be arranged so that the cards are accurately positioned on the second transfer device. These distances can be very slightly greater than those of the cards.

In certain embodiments, blowing means (S) are placed above the space separating the rotation shafts (A) and are arranged to generate a flow pressing the cards (1) onto the flaps (V) and facilitating the descent of the cards (1) in the lift device. In certain variants, the flow generated by the blowing means (S) is discontinuous and synchronized with the rotation (R) of the shafts (A). In further variants, this flow can be continuous.

In the embodiments comprising several pairs of shafts (A), and in particular in the case where each shaft comprises 4 flaps, the rotation (R) of the shafts and the distribution of the flaps (V) protect the card in the process of descent from another card which could arrive unexpectedly. No card can be on the same level.

Clearly, for persons skilled in the art, the present invention allows embodiments in many other specific forms without departing from the field of application of the invention as claimed. Consequently, the present embodiments must be considered illustrative and capable of modification within the field defined by the scope of the attached claims, the invention not being limited to the details given above.

1. Lift device for machine(s) for the personalization of cards, in particular chip cards, placed at the output of a first transfer device of a personalization machine and at the input of a second transfer device, the first transfer device being located at a height greater than the height at which the second transfer device is located, both transfer devices conveying the cards in a direction of movement, wherein the lift device comprises at least one pair of shafts spaced apart by a distance greater than the dimensions of the cards transversally to their direction of movement, each of the shafts being parallel to the direction of movement and equipped with a plurality of N flaps oriented parallel to the shaft, having dimensions arranged to support at least a part of the cards and radially distributed around the shaft every 360°/N, the shafts of a pair being synchronously driven by at least one driving means in rotation towards the inside and towards the bottom of the lift device, so that two flaps guide a card during its descent in the lift device.

2. Device according to claim 1, wherein the shafts each comprise four flaps and are driven in rotation by steps of one quarter-turn.

3. Device according to claim 1, comprising two pairs of shafts driven synchronously in rotation, one pair, called the upper pair, being placed substantially in the plane of, or below, the first transfer device and one pair, called the lower pair, being placed between the upper pair and the second transfer device.

4. Device according to claim 1, wherein at least one sensor is placed at the output of the first transfer device and arranged for detecting the arrival of a card and initiating the rotation of the shafts.

5. Device according to claim 1 wherein at least one sensor is placed at the input of the second transfer device and arranged for detecting the arrival of a card on the second transfer device.

6. Device according to claim 5, wherein that the second transfer device operates by feed steps and the sensor placed at the input of this second device is also arranged for controlling the feed of the latter when a card is detected.

7. Device according to claim 3, wherein the distance separating the shafts of the lower pair is less than the distance separating the shafts of the upper pair.

8. Device according to claim 1, wherein at least one of the transfer devices is a conveyor belt.

9. Device according to claim 1, wherein at least one of the transfer devices is a cleated conveyor.

10. Device according to claim 1, wherein the flaps protrude, for each shaft of a pair, with respect to a side wall, the distance separating the side walls close to the second transfer device being less than the distance separating these walls close to the first transfer device, so as to guide the cards during their descent in the lift device.

11. Device according to claim 1, wherein a wall, called a joining wall, oriented in a substantially vertical plane perpendicular to the rotation shafts is located within the height separating the output of the first transfer device and the input of the second transfer device.

12. Device according to claim 11, wherein the joining wall is substantially inclined in the direction of feed of the transfer devices, so as to guide the cards during their descent in the lift device.

13. Device according to claim 1, wherein a wall, called a stop wall, oriented in a substantially vertical plane perpendicular to the rotation shafts is located close to the end of the shafts opposite the output of the first transfer device.

14. Device according to claim 13, wherein the stop wall is substantially inclined in a direction opposite to the direction of feed of the transfer devices, so as to guide the cards during their descent in the lift device.

15. Device according to claim 1, wherein blowing means are placed above the space separating the rotation shafts and are arranged for generating a flow pressing the cards onto the flaps and facilitating the descent of the cards in the lift device.

16. Device according to claim 15, wherein the flow generated by the blowing means is synchronized with the rotation of the shafts.

17. Device according to claim 1, located in a personalization machine comprising the two transfer devices.

18. Device according to claim 1, located between two personalization machines each comprising one of the two transfer devices.

19. Card personalization machine comprising at least one card personalization station, at least one transfer device, and a lift device according to claim 1.
